(19) United States
(12) Patent Application Publication
(10) Pub. No.: US 2018/0191181 A1
(43) Pub. Date: Jul. 5, 2018

(54) CHARGING UNIT FOR MOBILE DEVICE

(71) Applicant: Sphero, Inc., Boulder, CO (US)

(72) Inventors: David Emery Hygh, Broomfield, CO (US); Quentin E. Michelet, Boulder, CO (US); Adam R. Short, Superior, CO (US)

(73) Assignee: Sphero, Inc., Boulder, CO (US)

(21) Appl. No.: 15/398,109

(22) Filed: Jan. 4, 2017

(51) Int. Cl. H02J 7/00; H01R 13/22

(52) U.S. Cl. CPC H02J 7/0042; H01R 13/22; H01R 2103/00; H02J 7/0047; H02J 7/007

(57) ABSTRACT

An apparatus has a base with a first, second, and third electrical contact exposed on the base. A circuitry connected to the electrical contacts is configured to set a polarity of the first and second electrical contacts based on an identification signal received by the first and second electrical contacts.

Mobile devices such as robots (autonomous, semi-autonomous, or otherwise) typically utilize some type of structure to recharge one or more on-board batteries. The structure may also be used to transmit data or other non-power signals. Such structures may include wire-based or contact-based charging systems. Wire-based systems may include cords, such as USB or other types of cabling that may be plugged into a port on the robot. Such wired systems often require the action of a user to plug in the robot for charging. In contact-based systems, the robot may include a number of exposed contacts that mate with matching contacts on a base station associated with the robot. These contact systems, which may not require human action for operation, often require precise alignment of the robot so as to ensure proper mating of contacts.

### SUMMARY

In one aspect, the technology relates to an apparatus having: a base; a plurality of electrical contacts exposed on the base, wherein the plurality of electrical contacts includes a first electrical contact, a second electrical contact, and a third electrical contact; and circuitry connected to the plurality of electrical contacts, wherein the circuitry is configured to set a polarity of the first electrical contact and the second electrical contact based at least in part on an identification signal received by the first electrical contact and the second electrical contact. In an example, the circuitry is configured to set the polarities of each of the plurality of electrical contacts to at least one of a positive polarity and a negative polarity. In another example, the circuitry is configured to electrically disconnect each of the plurality of electrical contacts from the circuitry. In yet another example, the circuitry is configured to (1) set polarities of the first electrical contact and the second electrical contact to a first polarity and (2) set a polarity of the third electrical contact to a second polarity different than the first polarity. In still another example, the first electrical contact is disposed adjacent the second electrical contact.

In another example of the above aspect, the first electrical contact and the second electrical contact are disposed so as to both contact a single charging prong of a device disposed on the base. In an example, the apparatus further includes a fourth electrical contact exposed on the base and connected to the circuitry. In another example, the circuitry is configured to set a polarity of the fourth electrical contact to the first polarity. In yet another example, the circuitry is configured to set a polarity of the fourth electrical contact to the second polarity. In still another example, the fourth electrical contact is adjacent to both the first electrical contact and the second electrical contact.

In another example of the above aspect, the apparatus further includes a fifth electrical contact exposed on the base and connected to the circuitry. In an example, the circuitry is configured to set a polarity of the fifth electrical contact to the first polarity. In another example, the circuitry is configured to set a polarity of the fifth electrical contact to the second polarity.

In another aspect, the technology relates to a method of charging a device with a charging unit having a first electrical contact and a second electrical contact, the method including: sending a test signal to a device from the first electrical contact; receiving the test signal from the device at the second electrical contact; sending a return signal to the device from the second electrical contact; receiving the return signal from the device at the first electrical contact; comparing the received test signal to the received return signal; and when the received test signal is different than the received return signal: setting a polarity of each of the first electrical contact and the second electrical contact; and initiating a signal from at least one of the first electrical contact and the second electrical contact to the device. In an example, the method further includes detecting a short between (1) at least one of the first electrical contact and the second electrical contact and (2) a third electrical contact of the charging unit. In another example, the method further includes detecting the short between the first electrical contact and the third electrical contact; and setting the polarity of the third electrical contact to be the same as the polarity of the first electrical contact. In yet another example, an identifying characteristic of the sent test signal and an identifying characteristic of the sent return signal are substantially identical. In still another example, the identifying characteristic of the received test signal and the identifying characteristic of the received return signal are different. In another example, the identifying characteristic of the received test signal and the identifying characteristic of the received return signal includes at least one of a voltage, a current, and a data.

In another aspect, the technology relates to a system having: a mobile device having: a body; and a first charging prong extending from the body in a deployed configuration; and a second charging prong extending from the body in a deployed configuration, wherein when the first charging prong and the second charging prong are in the deployed configurations, the first charging prong and the second charging prong are separated by a deployed distance; and a charging unit having: a base; and a plurality of electrical contacts exposed on the base, wherein each the first charging prong and the second charging prong are configured to operably contact any of the plurality of electrical contacts, and wherein a contact maximum linear dimension of any of the plurality of electrical contacts is less than the deployed distance. In an example, the first charging prong and the second charging prong each include a prong minimum linear dimension and wherein adjacent electrical contacts of the plurality of electrical contacts are separated by a linear separation distance less than the prong minimum linear dimension of each of the first charging prong and the second charging prong. In another example, the plurality of electrical contacts includes three electrical contacts arranged such that the first charging prong can simultaneously contact the three electrical contacts. In yet another example, the plurality of electrical contacts include a hexagonal electrical contact disposed at a center of the base and six partial hexagonal electrical contacts disposed about the hexagonal contact.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 depicts a perspective view of a system including a mobile device and a charging unit.

FIG. 2 depicts a top view of a charging unit.

FIG. 3 depicts a schematic circuit diagram of a charging unit.

FIG. 4 depicts a schematic diagram of a scanning circuit for a charging unit.

FIG. 5 depicts a schematic diagram of an identification circuit for a mobile device.

FIGS. 6A-6E depict a system having a mobile device and a charging unit.

FIG. 7 depicts a top view of another example of a charging unit.

FIG. 8 depicts a method of charging a mobile device.

### DETAILED DESCRIPTION

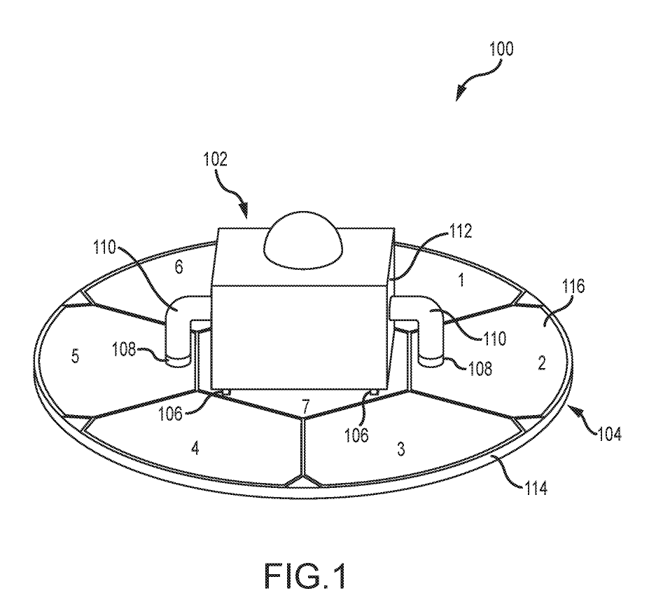

FIG. 1 depicts a perspective view of a system 100 including a mobile device 102 and a charging unit 104. The mobile device 102 may be an autonomous, semi-autonomous, or user-controlled robot that contains its own on-board battery or batteries, circuitry, memory, motors, etc. In this example, the mobile device 102 includes a plurality of treads or wheels 106 which enable movement of the device 102 within an environment (e.g., home, office, laboratory, etc.). The mobile device 102 may be sized and configured so as to be able to mount the charging unit 104. The device 102 also includes a plurality of charging prongs 108 that may be disposed on the ends of deployable arms 110 that extend from a body 112 of the device 102. Although the arms 110 are depicted as extending from sides of the body, other placement and configurations are contemplated, as required or desired for a particular application. For example, the arms (and, by extension the prongs) may extend from an underside of the body 112. The charging unit 104 generally includes a substantially flat base 114 having disposed and exposed thereon a number of contacts 116. In the depicted example, individual contacts 116 are numbered 1-7. Circuitry within the base 114 may perform a number of functions as described herein, such as mobile device identification, mobile device status checks, mobile device charging, data uploading, data downloading, etc., as described in more detail herein. The configuration of the mobile device 102 and charging unit 104 enables the mobile device 102 to mount the charging unit 104 and position itself in a virtually unlimited number of positions, so as to engage with the charging unit 104, e.g., for power and/or data transfer. The structures and functions associated therewith are further described below.

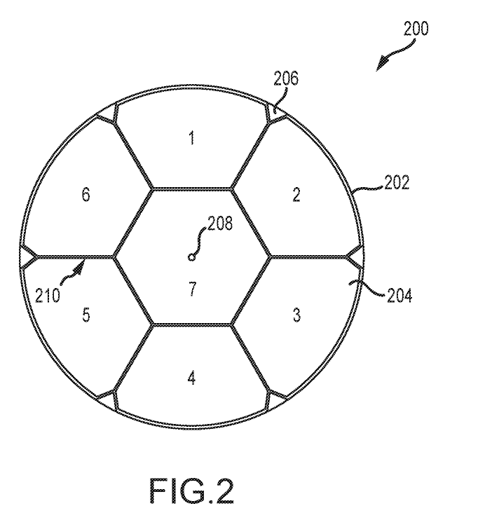

FIG. 2 depicts a top view of a charging unit 200. As noted above, the charging unit 200 includes a base 202, e.g., in the shape of a round pad or mat. Depending on the required or desired application, the base 202 may have a height of about 10 mm, about 15 mm, or about 20 mm. The height may be dictated by the structure of the mobile device 102 (e.g., wheel or tread height, ground clearance, etc.). The base 202 may be substantially flat or may have a slight convex curvature, with a peak proximate a center thereof. A plurality of electrical contacts 204 (numbered 1-7 in FIG. 2) are exposed on the base 202. In FIG. 2, a central contact 204-7 is hexagonally shaped. Contacts 204-1 through 204-6 have shapes of partial hexagons, with curved edges terminating proximate an outer perimeter of the base 202. A plurality of lights or other signal emitters 206 are disposed about the perimeter of the base 202, e.g., between adjacent contacts 204-1 through 204-6. These emitters 206 may be utilized in conjunction with sensors on the mobile device to allow the mobile device to locate, approach, and mount the base 202. A central light or other signal emitter 208 may be disposed at an internal area of the base 202. Here, the central emitter 208 is disposed at the center of the base 202 (and contact 204-7). If a base 202 having a convex raised center is utilized, disposing the central emitter 208 at the peak may make improve detection of the base 202 by the mobile device. The mobile device may utilize the signal received from the central emitter 208 as an indication to stop at a certain location on the base 202. Other procedures may be utilized to stop the mobile device on the base 202 to begin charging. For example, the mobile device may move to a portion of the base 202 where signals are received from a plurality of emitters 206, 208. Once a threshold number of signals are detected, the mobile device may stop and begin its charging procedure. In another example, the mobile device may move on the base 202 until it is a predetermined distance between two or more signal emitters 206, 208, at which time the charging procedure may begin. Other mounting procedures and criteria are contemplated, as required or desired for a particular application.

The signal emitters 206, 208 may serve other purposes. For example, multi-colored LEDs (or multiple LEDs having different colors) may be utilized to give a visual indication of a status associated with the charging unit 200. For example, the LEDs may emit a first color when the charging unit 200 is in a READY condition (e.g., waiting for a mobile device to mount the charging unit 200). Emission of a first color in a READY condition may increase the visibility of the charging unit, thus reducing the chance that the charging unit 200 may be inadvertently trampled. During a charging procedure, one or more of the signal emitters 206, 208 may emit a second, different color. Upon completion of a charging procedure, one or more of the signal emitters 206, 208 may emit a third color. A fourth color may be used if an error condition occurs. Although the signal emitters 206, 208 are described as changing colors, additionally or alternatively, emission patterns of the signal emitters 206, 208 may change (e.g., between constant emission, strobe, fade, and so on). Additionally, other signal emitters may be utilized, such as Bluetooth Smart, or Bluetooth Low Energy (aka BLE). Non-conductive gaps 210 separate adjacent electrical contracts 204-1 through 204-7.

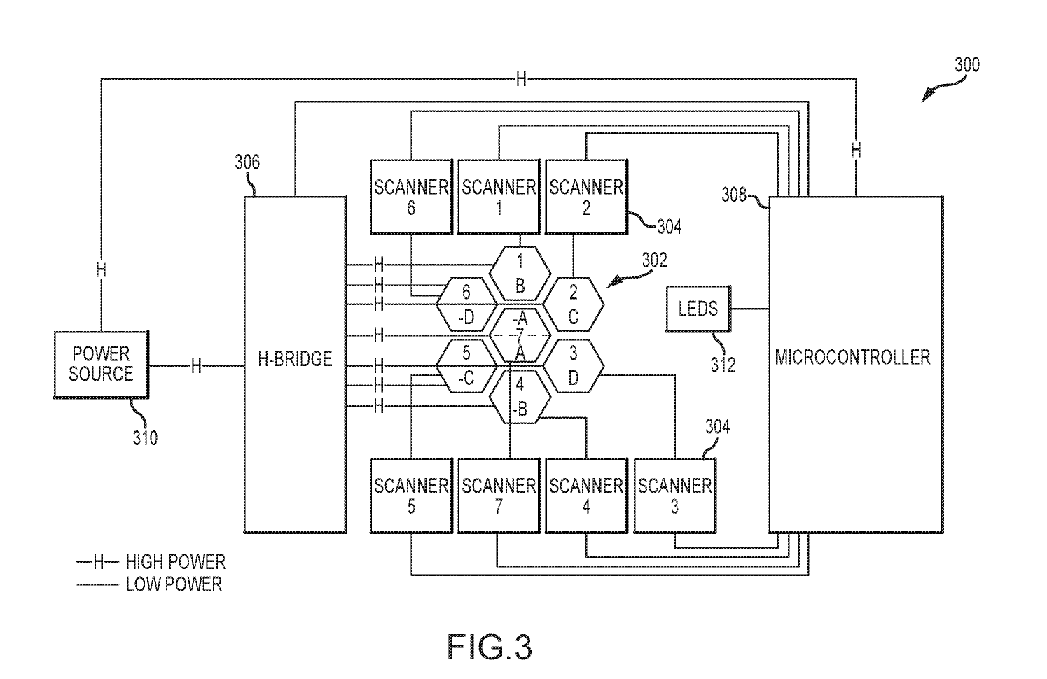

FIG. 3 depicts a schematic circuit diagram of a charging unit 300. The components depicted in FIG. 3 may typically be disposed in or on a base of a charging unit such as that depicted in FIG. 2, above. However, in other examples, only the contacts 302 may be exposed on the base, while the other depicted components may be disposed in a housing separate from the base. For example, the separate housing may be connected to a plug to be inserted into an outlet that provides building power. Such a separate housing may also include an A/C adapter or other components typically utilized to transform or convert power for electronic devices. The separate housing may then be connected by a cable to the base having the exposed contacts. Locating the other components in a separate housing may reduce the height, weight, and/or size of the base of the charging unit 300. FIG. 3, however, contemplates the components disposed in a single base of a charging unit 300.

Each electrical contact 302-1 through 302-7 has associated therewith a scanning circuit 304-1 through 304-7, the structure and function of which is described below. Power distribution to the contacts 302-1 through 302-7 is controlled through an H-bridge 306. A quad H-bridge chip 306 is depicted in FIG. 3, although discrete H-bridges may be utilized. In the case of a seven-contact charging unit 300, as depicted, four discrete H-bridges instead may be utilized. Regardless of the exact configuration H-bridge (e.g., a quad chip or discrete devices), each H-bridge is connected to contacts 302 disposed opposite each other on the base. These opposite contacts 302 are depicted by letters such as “B”, “-B”, “C”, “-C”, and so on. A single H-bridge may be connected to the central contact 302-7, for example, to both an “A” side of the contact 302-7, as well as an “-A” side. A microcontroller or processor 308 controls the various functions of the charging unit 300, as described in more detail herein. A power source module 310 may be one or more batteries (rechargeable or otherwise), a solar power source, or may be a component that connects to an external power source, such as a building power source. In other examples, the charging unit 300 may include a number of different power source modules 310, such as both a battery and a connector to access a building power source. In such a case, the microcontroller 308 may control the protocols required to select the desired power source based on source availability, mobile device charging requirements, or other considerations. LEDs 312 or other signal emitters are also depicted.

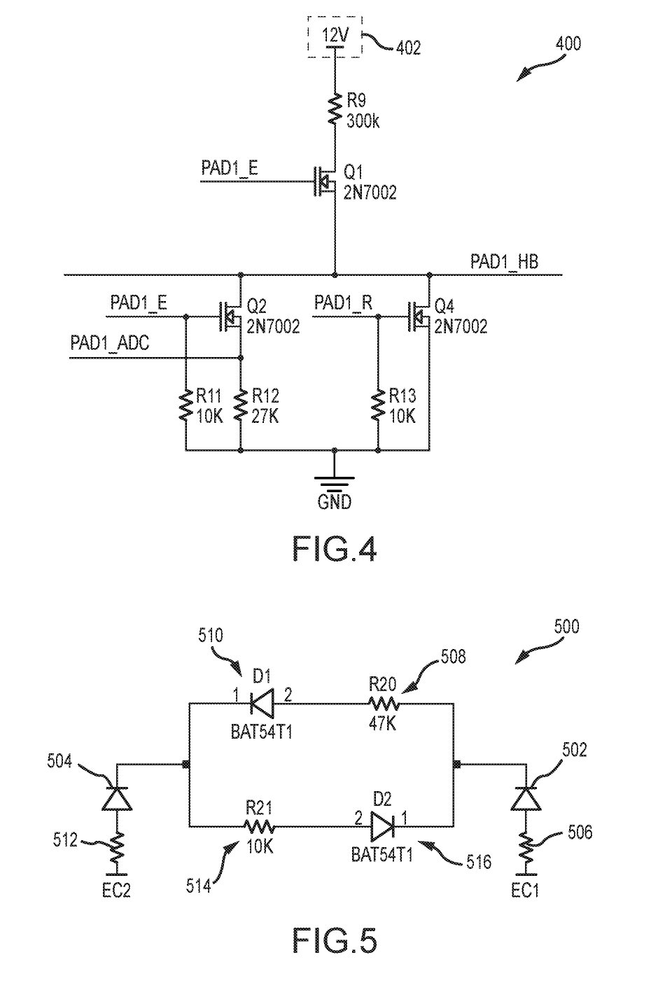

FIG. 4 depicts a schematic diagram of a scanning circuit 400 diagram for a charging unit, such as the charging units depicted herein. As depicted for example in FIG. 3, each contact 402 is associated with a dedicated scanning circuit 400, such as that depicted. A specific scanning circuit 400 is utilized to detect a structure disposed on its associated electrical contact 402. The structure may be a mobile device authorized to be charged by the contact pad, or may be an unauthorized device or object that cannot or should not be charged. Such unauthorized devices may include other mobile devices (e.g., robots manufactured by a different manufacturer), conductive objects that do not require charging (e.g., a metal fork or a human hand), or debris. The logic utilized in the scanning circuit 400 first determines if an object contacting an electrical contact 402 is, in fact, an authorized object (such procedures are described in more detail below). If the object is authorized and also detected at a second electrical contact, the microcontroller begins the charging procedure, sending a power via the H-bridges. For authorized devices, the object in contact with the electrical contacts 402 would be a charging prong extending from a robot. Similarly, data or other signals may also be sent and received before, during, or after the power signals. In certain examples, data signals may be sent instead of power signals.

FIG. 5 depicts a schematic diagram of an identification circuit 500 for a mobile device. The identification circuit 500 is on board the mobile device and is directly or indirectly communicatively coupled at either end to charging prongs 502, 504, such as those depicted on the robot of FIG. 1. Charging prong 502 is positive, while charging prong 504 is negative. Additional circuitry for the mobile device is not depicted. The scanning circuit, such as that depicted in FIG. 5, sends a first or test signal, having known characteristics (e.g., a known low voltage value, such as 1V), via an associated first electrical contact EC1 to the mobile device. The test signal 506 passes through the first charging prong 502 on the robot and passes through a first resistor 508 having a first resistance, before passing through a first diode 510. The test signal 506 passes out of the second charging prong 504 to a second electrical contact EC2 and to an associated second scanning circuit. Since the test signal 506 passed through the first resistor 508, certain characteristics of the test signal 506 will be different when received by the second scanning circuit. In the case of a 1V test signal 506 sent through the first resistor 508, a 0.6V signal is received at the second electrical contact EC2. The test signal 506 received at the second electrical contact EC2 is analyzed by the microcontroller and, if it meets certain predetermined criteria (e.g., the 0.6V value noted above), a return signal 512 is sent from the second scanning circuit, via the second electrical contact EC2, to the second charging prong 504 on the mobile device.

This return signal 512 passes through a second resistor 514 having a resistance different than that of the first resistor 508. The return signal 512 then passes through a second diode 516 before passing out of the first charging prong 502 to the first electrical contact EC1 and associated first scanning circuit. Here, if the return signal 512 was a 1V signal, a 0.3V signal is received at the first electrical contact EC1. The return signal 512 received at the first scanning circuit is analyzed by the microcontroller and, if it meets certain predetermined criteria (e.g., the 0.3V value noted above), the charging unit determines that an authorized item is, in fact, in contact with the first and second electrical contacts EC1, EC2. Additionally, given the voltages received at the first and second electrical contacts EC1, EC2, the charging unit is able to determine that the positive charging prong 502 is contact with the first electrical contact EC1 and the negative charging prong 504 is in contact with the second electrical contact EC2, thus enabling the charging device to properly set the polarities of both electrical contacts EC1, EC2, and initiate a charging or data transfer procedure.

The identification circuit 500 helps ensure that a charging procedure is not initiated on an unauthorized mobile device, or on an object, person, or pet that may contact multiple charging contacts of the charging unit. Thus, the identification circuit 500, when used in conjunction with the charging unit, prevents delivery of a charging signal across an object that, coincidentally, may have a resistance equal to that of the first resistor 508, but not the second resistor 514. As such, the chances of damage to the charging unit, or injury or damage to an unauthorized mobile device, object, person, or pet, is reduced or eliminated.

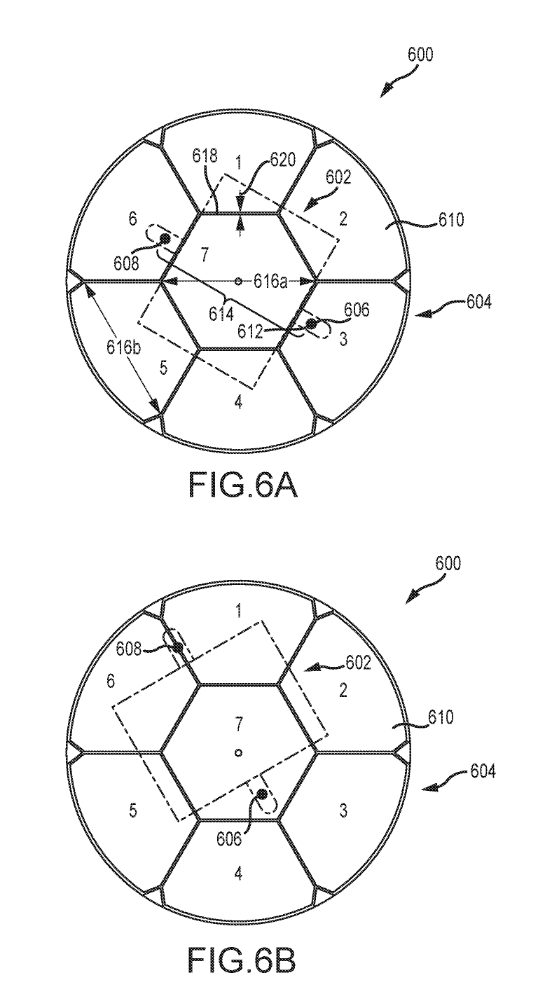

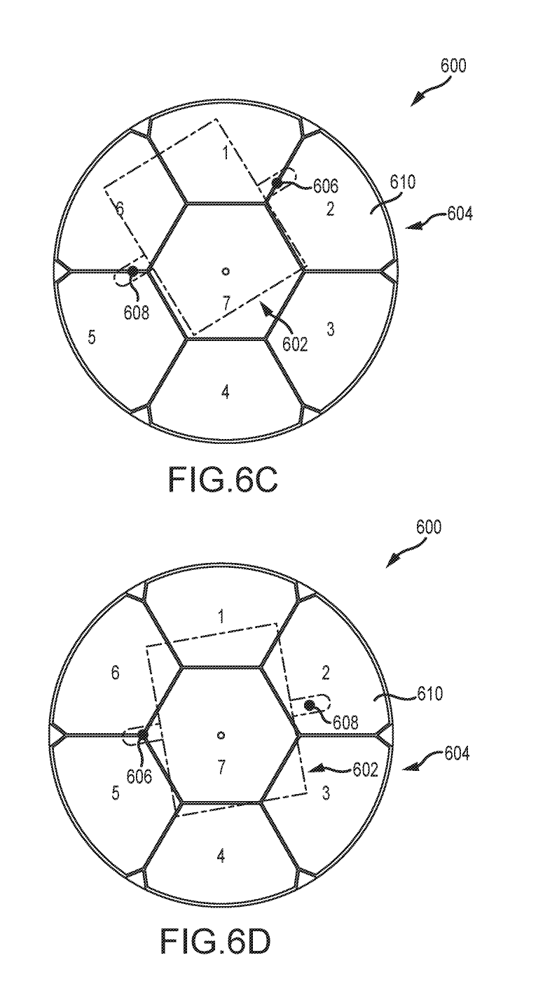

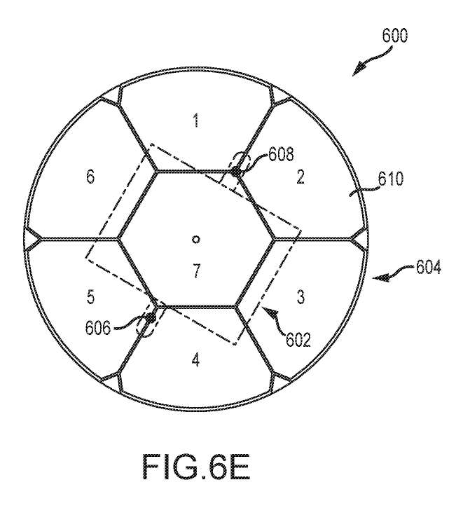

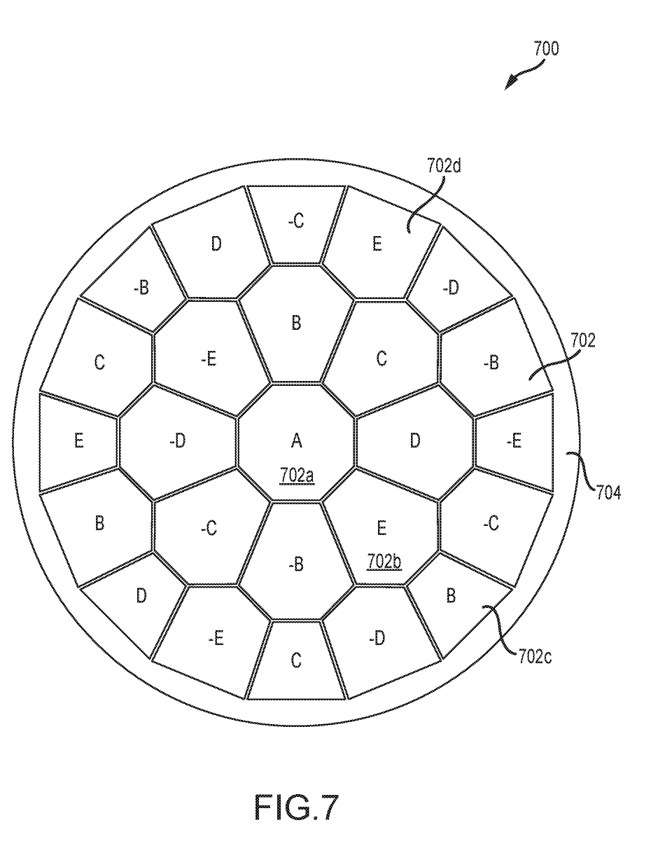

FIGS. 6A-6E depict a system 600 having a mobile device 602 and a charging unit 604, and more specifically, positions of a first charging prong 606 and second charging prong 608 relative to electrical contacts 610-1 through 610-7 on the charging unit 604. The system 600 displays certain dimensional relationships of the various components thereof that prevent the two charging prongs 606, 608 from contacting the same electrical contact 610-1 through 610-7. Additionally, the system 600 displays certain dimensional relationships and functionality that allow a charging and/or data transfer procedure to operate, even if either or both of the charging prongs 606, 608 are in contact with more than one of the electrical contacts 610-1 through 610-7. These dimensional relationships are described further below.

With regard to the mobile device 602, each charging prong 606, 608 comprises a prong minimum linear dimension 612. In the case of a round charging prong, such as those depicted in FIGS. 6A-6E, the prong minimum linear dimension 612 is the diameter of the surface of the charging prong 606, 608 that contacts the charging unit 604. In the case of charging prongs utilizing different shapes, the prong minimum linear dimension may be measured as required, depending on the prong shape. For example, the prong minimum linear dimension of a charging prong having an oval shape may be the length of the minor axis thereof. In an example of a charging prong having a rectangular shape, the prong minimum linear dimension may be the length of the shortest side. When deployed into a position that enables charging of the mobile device, the charging prongs 606, 608 are separated by a center-to-center deployed distance 614. This deployed distance 614, when used in conjunction with a charging unit 604 having properly dimensioned electrical contacts 610-1 through 610-7, prevents both charging prongs 606, 608 from contacting the same electrical contact.

With regard to the charging unit 604, each electrical contact 610-1 through 610-7 includes a contact maximum linear dimension 616. For electrical contacts having regular geometric shapes (such as the regular hexagon of electrical contact 610-7), the contact maximum linear dimension 616a is generally the diameter of the hexagon. For electrical contacts having irregular geometric shapes (such as the partial hexagons of electrical contacts 610-1 through 610-6), the contact maximum linear dimension 616b is generally the longest dimension of the partial hexagon. Lastly, each of the electrical contacts 610-1 through 610-7 are separated from an adjacent electrical contacts 610-1 through 610-7 by gaps 618 having a linear separation distance 620 measured along a line orthogonal to both edges of adjacent electrical contacts (e.g., between electrical contacts 610-1 and 610-7).

The dimensional relationships between the prong minimum linear dimension 612 and the linear separation distance 620, as well as between the center-to-center deployed distance 614 and the contact maximum linear dimension 616 allow the mobile device 602 to be positioned in a nearly infinite number of positions on the charging unit 604 and properly receive power and/or data signals from the charging unit 604. This is described in further detail below. For example, as depicted in FIG. 6A, the deployed distance 614 is greater than the contact maximum linear dimension 616. Thus, when one charging prong 606 is placed on a certain electrical contact 610-3, it is impossible for the other charging prong 608 to be placed on the same contact. Thus, the ability to initiate a charging or data transfer procedure (whereby a first contact is set to a positive polarity and a second contact is set to a negative polarity), is ensured.

A number of charging prong positions relative to the electrical contacts are depicted in FIGS. 6A-6E, and are described in more detail below. The reference numerals introduced in FIG. 6A are utilized consistently within FIGS. 6A-6E and, as such, certain components are not necessarily described in detail in all of the figures. Beginning with FIG. 6A, an authorized mobile device 602 such as a robot is depicted schematically on a charging unit 604 such that each charging prong 606, 608 contacts a single electrical contact 610-3, 610-6, respectively. As such, once the mobile device 602 is positioned as depicted, the circuitry within the charging unit 604 sets one of the electrical contacts 610-3 to a positive polarity and the other electrical contact 610-6 to a negative polarity during a charging procedure. It should be noted that either electrical contact 610-3, 610-6 may be set or assigned to either a positive or negative polarity by the circuitry, as required or desired.

In FIG. 6B, an authorized mobile device 602 is depicted schematically on a charging unit 604 such that a first charging prong 606 contacts a single electrical contact 610-7. A second charging prong 608 contacts two electrical contacts 610-1, 610-6. Since the prong minimum linear dimension 612 is greater than the linear separation distance 620, the second charging prong 608 is able to span the gap 618, thereby contacting both electrical contacts 610-1, 610-6. A single charging prong 606, 608 will always contact at least one electrical contact 610, and in some cases, will contact two or even three adjacent electrical contacts 610. The circuitry within the charging unit 604 detects a short between the two electrical contacts 610-1, 610-6, and sets those electrical contacts 610-1, 610-6 to the same polarity (e.g., positive). The single electrical contact 610-7 contacting the first charging prong 606 is set to the opposite polarity (e.g., negative). Thus, even in a case where a charging prong contacts two electrical contacts, charging and data transfer operations may still occur.

In FIG. 6C, an authorized mobile device 602 is depicted schematically on a charging unit 604 such that a first charging prong 606 contacts two electrical contacts 610-1, 610-2, while a second charging prong 608 also contacts two electrical contacts 610-5, 610-6. The circuitry within the charging unit 604 detects shorts between electrical contacts 610-1, 610-2, and sets those electrical contacts 610-1, 610-2 to the same polarity (e.g., negative). The circuitry within the charging unit 604 detects shorts between electrical contacts 610-5, 610-6, and sets those electrical contacts 610-5, 610-6 to the opposite polarity (e.g., positive). Charging and data transfer operations may still occur under this configuration.

In FIG. 6D, an authorized mobile device 602 is depicted schematically on a charging unit 604 such that a first charging prong 606 contacts three electrical contacts 610-5, 610-6, 610-7, while a second charging prong 608 contacts a single electrical contact 610-2. The circuitry within the charging unit 604 detects a short between electrical contacts 610-5, 610-6, 610-7, and sets those electrical contacts 610-5, 610-6, 610-7 to the same polarity (e.g., negative). The circuitry within the charging unit 604 sets the electrical contact 610-2 to the opposite polarity (e.g., positive). Charging and data transfer operations may still occur under this configuration.

In FIG. 6E, an authorized mobile device 602 is depicted schematically on a charging unit 604 such that a first charging prong 606 contacts two electrical contacts 610-4, 610-5, while a second charging prong 608 contacts three electrical contacts 610-1, 610-2, 610-7. The circuitry within the charging unit 604 detects shorts between electrical contacts 610-4, 610-5, and sets those electrical contacts 610-4, 610-5 to the same polarity (e.g., positive). The circuitry within the charging unit 604 detects shorts between electrical contacts 610-1, 610-2, 610-7, and sets those electrical contacts 610-1, 610-2, 610-7 to the opposite polarity (e.g., negative). Charging and data transfer operations may still occur under this configuration.

As can be seen from the above FIGS. 6A-6E, the configurations and dimensions of the prong minimum linear dimension 612, the linear separation distance 620, the deployed distance 614, and the contact maximum linear dimension 616 allow for charging and data transfer regardless of the position of the mobile device 602 on the charging unit 604. As such, the mobile device 602 may approach and mount the charging unit 604 from virtually any direction. Thus, the charging unit 604 need not be carefully placed to ensure access thereto. Additionally, although alignment contact problems plague prior art devices, the assignability of the poles of the exposed contacts (as well as the ability to set or assign the same polarity to more than two contacts) enable a mobile device 602 to deploy its charging prongs 606, 608 virtually anywhere on the charging unit 604. Moreover, in certain instances depicted, the mobile device 602 need not be completely on the charging unit for charging to occur.

FIG. 7 depicts a top view of another example of a charging unit 700, which includes twenty-five discrete electrical contacts 702, arranged symmetrically about the center of the base 704. A single octagonal electrical contact 702a is disposed in the center of the base 704. Arranged around the octagonal electrical contact 702a are eight irregular hexagonal electrical contacts 702b. Two sets of outer contacts 702c, 702d are alternatingly disposed around the irregular hexagonal electrical contacts 702b. Irregular trapezoidal electrical contacts 702c abut a single edge of only one of the irregular hexagonal electrical contacts 702b. Irregular pentagonal electrical contacts 702d are disposed between each irregular trapezoidal electrical contacts 702c and abut an edge of each of two adjacent irregular hexagonal electrical contacts 702b. As with the charging unit of FIGS. 6A-6B, the electrical contacts 702 (and linear separation distance therebetween) may be dimensioned so as to allow utilization by a properly-dimensioned mobile device (with regard to prong deployed distance and prong minimum linear dimension). The charging unit 700 includes the same or similar functionality to that of the other charging units described herein. Depending on the relative size of the charging unit 700, the number of contacts 702 thereon, and the size of the mobile device, a plurality of mobile devices may utilize the depicted charging unit 700 simultaneously. It is contemplated to modify the identification and charging controls to accommodate simultaneous charging of multiple mobile devices. Additionally, the “A”, “-A”, “B”, “-B”, etc., distribution indicates at least one configuration of H-bridge connections. In this example, four H-bridges may be utilized.

The charging unit depicted herein regularly emits signals in a detection session from the electrical contacts to detect the presence of a mobile device thereon. In an example, the detection session includes emitting a low-voltage signal from each of the electrical contacts and reading a result, if any, at the other electrical contacts. That is, in a detection session for a charging unit having seven electrical contacts, a low voltage (e.g., 1 V) signal is emitted from electrical contact 1, and signals received at electrical contacts 2-7 are recorded. Next, a low voltage signal is emitted from electrical contact 2, and signal received at electrical contacts 1 and 3-7 are recorded. This detection session continues until low voltage signals have been emitted from all of the seven electrical contacts. The signals received at each electrical contact indicate to the microcontroller of the charging unit the presence of a robot or other object on the charging unit and which electrical contacts are being contacted, thereby enabling the microprocessor to determine if it a charging procedure may begin. Table 1A depicts the voltage received at each electrical contact when a 1V signal is emitted from each of the electrical contacts. A reading of 0V at any electrical contact is indicative of a short with another contact. This example is consistent with the robot charging prong placement depicted in FIG. 6A, where the mobile device 602 has placed its charging prongs 606, 608 on electrical contacts 610-3 and 610-6, respectively. Here, since the reading at electrical contact 610-6 is 0.6V and the reading at electrical contact 610-3 is 0.3V, the charging unit determines that the positive charging prong 606 is present on electrical contact 610-3, while the negative charging prong 608 is present on electrical contact 610-6. The polarities of each electrical contact 610-3, 610-6 are properly set and a charging procedure may be initiated.

TABLE 1A
Voltages Detected at Electrical Contacts (FIG. 6A)

| 1 V Emission | | | | | | | |
|---|---|---|---|---|---|---|---|
| from Electrical | Voltage Detected at Electrical Contact | | | | | | |
| Contact | 610-1 | 610-2 | 610-3 | 610-4 | 610-5 | 610-6 | 610-7 |
| 610-1 | — | 1 | 1 | 1 | 1 | 1 | 1 |
| 610-2 | 1 | — | 1 | 1 | 1 | 1 | 1 |
| 610-3 | 1 | 1 | — | 1 | 1 | 0.6 | 1 |
| 610-4 | 1 | 1 | 1 | — | 1 | 1 | 1 |
| 610-5 | 1 | 1 | 1 | 1 | — | 1 | 1 |
| 610-6 | 1 | 1 | 0.3 | 1 | 1 | — | 1 |
| 610-7 | 1 | 1 | 1 | 1 | 1 | 1 | — |

Table 1B depicts the voltage received at each electrical contact when a 1V signal is emitted from each of the electrical contacts. A reading of 0V at any electrical contact is indicative of a short with an adjacent contact. This example is consistent with the robot charging prong placement depicted in FIG. 6B, where the mobile device 602 has placed its charging prong 606 on electrical contact 610-7, and its charging prong 608 on both electrical contacts 610-1 and 610-6. Here, since the readings at electrical contact 610-7 are 0.3V, this indicates to the charging unit that the positive charging prong 606 is in contact with electrical contact 610-7. Also, since this 0.3V signal is received at electrical contact 610-7 twice, the charging device is able to determine that both electrical contacts 610-1 and 610-6 are contacting negative charging prong 608. The detected 0V at both electrical contacts 610-1 and 610-6 indicate a short between those electrical contacts (due to spanning of the gap 618 by negative charging prong 608. The receipt of a 0.6V signal at both electrical contacts 610-1 and 610-6 in response to a 1V signal sent from electrical contact 610-7 further confirms that an authorized device is present on the charging unit. Thus, the polarities of each electrical contact 610-1, 610-6, 610-7 are properly set and a charging procedure initiated. Voltage tables for other prong placements (e.g., the other configurations depicted in FIGS. 6C-6E, and others) would be apparent to a person of skill in the art.

TABLE 1B
Voltages Detected at Electrical Contacts (FIG. 6B)

| 1 V Emission | | | | | | | |
|---|---|---|---|---|---|---|---|
| from Electrical | Voltage Detected at Electrical Contact | | | | | | |
| Contact | 610-1 | 610-2 | 610-3 | 610-4 | 610-5 | 610-6 | 610-7 |
| 610-1 | — | 1 | 1 | 1 | 1 | 0 | 0.3 |
| 610-2 | 1 | — | 1 | 1 | 1 | 1 | 1 |
| 610-3 | 1 | 1 | — | 1 | 1 | 1 | 1 |
| 610-4 | 1 | 1 | 1 | — | 1 | 1 | 1 |
| 610-5 | 1 | 1 | 1 | 1 | — | 1 | 1 |
| 610-6 | 0 | 1 | 1 | 1 | 1 | — | 0.3 |
| 610-7 | 0.6 | 1 | 1 | 1 | 1 | 0.6 | — |

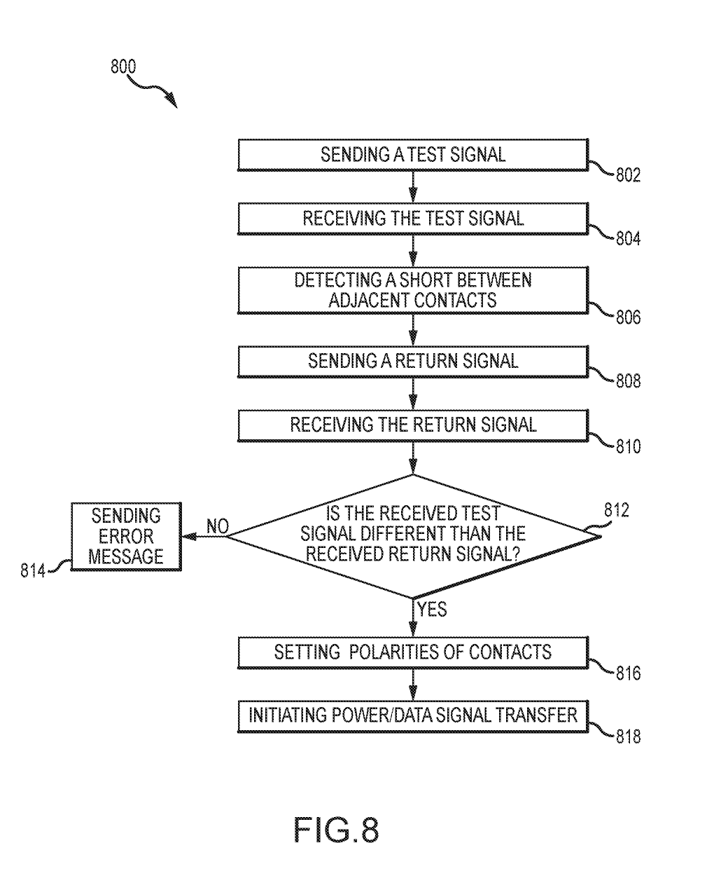

FIG. 8 depicts a method 800 of charging a mobile device and includes the use of identification signals such as test and return signals to properly identify a mobile device for charging. The test and return signals each include known characteristics such as voltage, current, waveform shape, etc., that enable identification thereof by a microprocessor disposed in the charging unit. In operation 802, a test signal of known characteristics is generated by a first scanner and emitted from a first electrical contact. Such test signals may be low-voltage signals continuously or regularly emitted by all of the electrical contacts of a charging unit. As such test signals are low-voltage, they would pose little to no risk to an object, person, or pet in contact with the charging unit. If an object, person, or pet is in contact with the electrical contacts, and is of sufficiently low impedance, the test signal will pass there through to be received by a second electrical contact and second scanner, at operation 804. In optional operation 806, if the test signal is also received at a third electrical contact adjacent the first electrical contact, this indicates a short between the first and third electrical contacts. Such a short is indicative of a charging prong of the mobile device contacting two (or three) adjacent electrical contacts.

In operation 808, upon receipt of the test signal at operation 804, the second scanner generates, and the second electrical contact sends a return signal in response to the test signal. The return signal is received at the first electrical contact and first scanner in operation 810. Thereafter, the received test signal and received return signal are compared in operation 812 for characteristics such as voltage, frequency, current, waveform shape, etc. If, the received test signal is not different from the received return signal, that is an indication that an authorized mobile device (e.g., a mobile device having an identification circuit such as depicted in FIG. 5) is not present on the charging unit, and flow branches NO. As such, charging and/or data transfer procedures will not begin and an error message may be sent, as depicted in operation 814. Such error messages may include an audible alarm sent by a piezoelectric or other speaker disposed in the charging unit and/or a visual alarm such as a change in color or emission rate of LEDs disposed on the charging unit. If the received test signal is different than the received return signal within predetermined parameters, this indicates that an authorized mobile device (as indicated by the presence of the identification circuit) is present on the charging unit and flow branches YES. As such, a charging and/or data transfer procedure may begin. This procedure may include operation 816, where polarities of the first and second electrical contacts are set to opposite polarities. In cases where shorts were detected between adjacent contacts, those adjacent contacts may also be set to the appropriate polarity. Contacts that did not receive any test signals may be electrically disconnected from the circuit. In operation 818, a power signal may be initiated. Alternatively or additionally, data signals may also be sent at this time. Charging and data transfer may continue as required or desired.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. An apparatus comprising:
a base;
a plurality of electrical contacts exposed on the base, wherein the plurality of electrical contacts comprises a first electrical contact, a second electrical contact, and a third electrical contact; and
circuitry connected to the plurality of electrical contacts, wherein the circuitry is configured to set a polarity of the first electrical contact and the second electrical contact based at least in part on an identification signal received by the first electrical contact and the second electrical contact.

2. The apparatus of claim 1, wherein the circuitry is configured to set the polarities of each of the plurality of electrical contacts to at least one of a positive polarity and a negative polarity.

3. The apparatus of claim 2, wherein the circuitry is configured to electrically disconnect each of the plurality of electrical contacts from the circuitry.

4. The apparatus of claim 1, wherein the circuitry is configured to (1) set polarities of the first electrical contact and the second electrical contact to a first polarity and (2) set a polarity of the third electrical contact to a second polarity different than the first polarity.

5. The apparatus of claim 4, wherein the first electrical contact is disposed adjacent the second electrical contact.

6. The apparatus of claim 5, wherein the first electrical contact and the second electrical contact are disposed so as to both contact a single charging prong of a device disposed on the base.

7. The apparatus of claim 4, further comprising a fourth electrical contact exposed on the base and connected to the circuitry.

8. The apparatus of claim 7, wherein the circuitry is configured to set a polarity of the fourth electrical contact to the first polarity.

9. The apparatus of claim 7, wherein the circuitry is configured to set a polarity of the fourth electrical contact to the second polarity.

10. The apparatus of claim 8, wherein the fourth electrical contact is adjacent to both the first electrical contact and the second electrical contact.

11. The apparatus of claim 7, further comprising a fifth electrical contact exposed on the base and connected to the circuitry.

12. The apparatus of claim 11, wherein the circuitry is configured to set a polarity of the fifth electrical contact to the first polarity.

13. The apparatus of claim 11, wherein the circuitry is configured to set a polarity of the fifth electrical contact to the second polarity.

14. A method of charging a device with a charging unit comprising a first electrical contact and a second electrical contact, the method comprising:
sending a test signal to a device from the first electrical contact;
receiving the test signal from the device at the second electrical contact;
sending a return signal to the device from the second electrical contact;
receiving the return signal from the device at the first electrical contact;
comparing the received test signal to the received return signal; and
when the received test signal is different than the received return signal:
setting a polarity of each of the first electrical contact and the second electrical contact; and
initiating a signal from at least one of the first electrical contact and the second electrical contact to the device.

15. The method of claim 14, further comprising:
detecting a short between (1) at least one of the first electrical contact and the second electrical contact and (2) a third electrical contact of the charging unit.

16. The method of claim 15, further comprising:
detecting the short between the first electrical contact and the third electrical contact; and
setting the polarity of the third electrical contact to be the same as the polarity of the first electrical contact.

17. The method of claim 14, wherein an identifying characteristic of the sent test signal and an identifying characteristic of the sent return signal are substantially identical.

18. The method of claim 17, wherein the identifying characteristic of the received test signal and the identifying characteristic of the received return signal are different.

19. The method of claim 18, wherein the identifying characteristic of the received test signal and the identifying characteristic of the received return signal comprise at least one of a voltage, a current, and a data.

20. A system comprising:
a mobile device comprising:
a body; and
a first charging prong extending from the body in a deployed configuration; and
a second charging prong extending from the body in a deployed configuration, wherein when the first charging prong and the second charging prong are in the deployed configurations, the first charging prong and the second charging prong are separated by a deployed distance; and
a charging unit comprising:
a base; and
a plurality of electrical contacts exposed on the base, wherein each the first charging prong and the second charging prong are configured to operably contact any of the plurality of electrical contacts, and wherein a contact maximum linear dimension of any of the plurality of electrical contacts is less than the deployed distance.

21. The system of claim 20, wherein the first charging prong and the second charging prong each comprise a prong minimum linear dimension and wherein adjacent electrical contacts of the plurality of electrical contacts are separated by a linear separation distance less than the prong minimum linear dimension of each of the first charging prong and the second charging prong.

22. The system of claim 20, wherein the plurality of electrical contacts comprises three electrical contacts arranged such that the first charging prong can simultaneously contact the three electrical contacts.

23. The system of claim 20, wherein the plurality of electrical contacts comprise a hexagonal electrical contact disposed at a center of the base and six partial hexagonal electrical contacts disposed about the hexagonal contact.
